(19) United States
(12) Patent Application Publication
(10) Pub. No.: US 2015/0135102 A1
(43) Pub. Date: May 14, 2015

(54) METHOD OF MANAGING DIGITAL IMAGE, COMPUTER READABLE STORAGE MEDIUM RECORDING THE METHOD, AND DIGITAL IMAGE MANAGING ELECTRONIC APPARATUS

(71) Applicant: SAMSUNG ELECTRONICS CO., LTD., Suwon-si (KR)

(72) Inventors: Jong-soo Sung, Seoul (KR); Jong-yun Lee, Suwon-si (KR)

(21) Appl. No.: 14/525,510

(22) Filed: Oct. 28, 2014

(30) Foreign Application Priority Data
Nov. 8, 2013 (KR) 10-2013-0135847

(51) Int. Cl. G06F 3/0484; G06F 17/30

(52) U.S. Cl. CPC G06F 3/0484; G06F 17/30117
USPC 715/763

(57) ABSTRACT

A method of managing digital images is disclosed. The method includes displaying images that a user may select; setting, by selection from images displayed on a display unit, a representative image and subsidiary images based on user input; creating a file including the representative image and the subsidiary images; and managing a plurality of images included in the file, based on the representative image corresponding to the created file.

### CROSS-REFERENCE TO RELATED PATENT APPLICATIONS

This application claims the priority benefit of Korean Patent Application No. 10-2013-0135847, filed on Nov. 8, 2013, in the Korean Intellectual Property Office, the disclosure of which is incorporated herein by reference in its entirety.

### BACKGROUND

1. Field

Various embodiments of the present disclosure relate to a method of managing digital images by using a representative image, a computer readable storage medium having computer readable instructions stored thereon that when executed by a processor cause the processor to implement the method, and a digital image managing electronic apparatus.

2. Related Art

With the development of multimedia and communication technology, users are able to access content using a variety of devices, in a variety of environments. For example, in addition to telephony, smart phones provide diverse functions including internet communications, a digital camera, an MP3 player, a game machine, access to broadcast content, internet banking, etc. Thus, it is possible for a device to create and manage multiple sources of content. Accordingly, there is a demand for devices that enable easy and efficient management of multiple sources of content according to intent of a user.

### SUMMARY

Various embodiments of the present disclosure include a method of managing digital images by using a representative image, wherein the method collectively manages a plurality of images by creating one file having a representative image and subsidiary images that have been selected by a user.

Additional embodiments are set forth in the following description.

According to various embodiments, a method of managing digital images includes displaying images that a user may select; setting by selection from images displayed on a display unit, a representative image and subsidiary images based on user input; creating a file including the representative image and the subsidiary images; and managing a plurality of images included in the file that are based on the representative image.

According to an embodiment, the representative image in the file may be reset to one of a plurality of subsidiary images included in the file, based on user input.

According to an embodiment, the subsidiary images included in the file may be added or deleted based on user input.

According to an embodiment, a method of managing a plurality of digital images included in a file, is disclosed, wherein the method includes displaying a representative image corresponding to the created file on the display unit, together with a predetermined mark.

According to an embodiment, the predetermined mark is a user interface that enables a user to select whether or not to display the subsidiary images included in the file.

According to an embodiment, a method of managing digital images is disclosed, wherein the method includes displaying the subsidiary images, included in the file, on the display unit based on user input to the user interface.

According to an embodiment, a method of managing digital images is disclosed, wherein the method of includes operations for sending a plurality of images, included in the file, corresponding to the representative image, when the representative image is sent.

According to an embodiment, a method of managing a plurality of digital images included in a file, is disclosed, wherein the method includes deleting the plurality of images corresponding to the representative image, when the representative image is deleted.

According to an embodiment, a digital image managing apparatus includes a display unit for displaying images stored in the digital image managing apparatus; a user input unit for receiving a signal for setting a representative image and subsidiary images by selection from images displayed on the display unit; a file creating unit for creating a file including the representative image and the subsidiary images that are set based on the signal received in the user input unit; and a control unit for managing a plurality of images included in the file, based on the representative image, corresponding to the file created in the file creating unit.

According to an embodiment, the representative image of the file may be reset to one of a plurality of subsidiary images included in the file, based on the user input.

According to an embodiment, the subsidiary images included in the file may be added or deleted, based on the user input.

According to an embodiment, the control unit of the digital image managing apparatus, with regard to displaying the created file on the display unit, may control the representative image, corresponding to the file, to be displayed on the display unit, together with a predetermined mark.

According to an embodiment, the control unit of the digital image managing apparatus may control a user interface, which enables a user to select whether or not to display, on the display unit, the subsidiary images included in the file together with a representative image.

According to an embodiment, the user input unit of the digital image managing apparatus may receive a signal indicating whether or not to display the subsidiary images included in the file, and the control unit may control the display of the subsidiary images based on the received signal in the user input unit.

According to an embodiment, when the representative image is sent, the control unit of the digital image managing apparatus may control the file corresponding to the representative image to be sent.

According to an embodiment, when the representative image is deleted, the control unit of the digital image managing apparatus may control the file corresponding to the representative image to be deleted.

According to an embodiment, a non-transitory computer readable storage medium having computer program instructions stored thereon is disclosed. The computer program instructions, when executed by a processor, cause the processor to perform a method of managing digital images. The includes displaying images which a user may select; setting a representative image and subsidiary images, based on a user input selection from images displayed on a display unit; creating a file including the representative image and the subsidiary images; and managing a plurality of images included in the file, based on the representative image corresponding to the created file.

According to an embodiment, the representative image of the file may be reset, based on a user input selection of an image from subsidiary images included in the file.

According to an embodiment, the subsidiary images included in the file may be added or deleted based on user input.

According to an embodiment, a method of managing digital images included in a file, is disclosed, wherein the method includes sending the plurality of images, corresponding to the representative image, when the representative image is sent.

According to an embodiment, a method of managing a plurality of digital images included in a file, is disclosed, wherein the method includes deleting images corresponding to the representative image when the representative image is deleted.

### BRIEF DESCRIPTION OF THE DRAWINGS

These and/or other embodiments will become apparent and more readily appreciated from the following description of various embodiments, taken in conjunction with the accompanying drawings.

FIG. 1 is a block diagram illustrating a digital image managing apparatus that creates and manages a file including a representative image, according to an embodiment.

FIG. 2 is a flowchart illustrating a method of creating and managing a file including a representative image, according to an embodiment.

FIG. 3 is a diagram illustrating an example user interface for selecting a representative image and subsidiary images in the digital image managing apparatus according to an embodiment.

FIG. 4A is a schematic illustration of a first file structure, according to an embodiment.

FIG. 4B is a schematic illustration of a second file structure, according to an embodiment.

FIG. 5 is a flowchart of a method of displaying a file including a representative image, according to an embodiment.

FIG. 6 is a schematic illustration of an example embodiment for displaying a file including a representative image and subsidiary images in a display unit, according to an embodiment.

FIG. 7 is a schematic illustration of a further example embodiment for displaying a file including a representative image and subsidiary images in a display unit, according to an embodiment.

FIG. 8 is a diagram illustrating an example method of sending a file in the digital image managing apparatus, according to an embodiment.

FIG. 9 is a schematic illustration of a method of deleting a file in the digital image managing apparatus, according to an embodiment.

FIG. 10 is a schematic illustration of a further method of deleting a file in the digital image managing apparatus, according to an embodiment.

### DETAILED DESCRIPTION

As the invention allows for various changes and numerous embodiments, particular embodiments are illustrated in the drawings and described in detail in the written description. However, the description of particular embodiments is not intended to limit the invention to particular modes of practice, and it is to be appreciated that all changes, equivalents, and substitutes that do not depart from the spirit and technical scope of the invention are encompassed by the invention. In the description of the invention, certain detailed explanations of the related art are omitted when it is deemed that they may unnecessarily obscure the essence of the invention.

While such terms as “first,” “second,” etc., may be used to describe various components, such components are not limited to the above terms. The above terms are used only to distinguish one component from another.

The terms used in the present specification are merely used to describe particular embodiments, and are not intended to limit the invention. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, exemplary embodiments are described below in more detail with reference to the accompanying drawings. Those components that are the same or are in correspondence are indicated by the same reference numeral regardless of the figure number, and redundant explanations are omitted.

As used herein, expressions such as “at least one of,” when preceding a list of elements, modify the entire list of elements and do not modify the individual elements of the list.

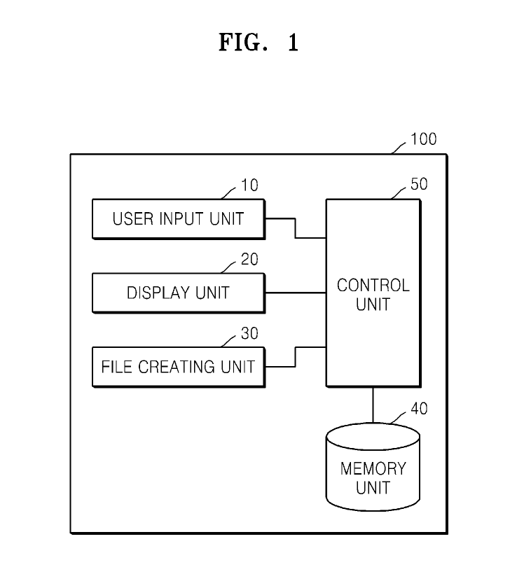

FIG. 1 is a block diagram illustrating a digital image managing apparatus 100 that creates and manages a file including a representative image, according to an embodiment.

As illustrated in FIG. 1, the digital image managing apparatus 100 may include a user input unit 10, a display unit 20, a file creating unit 30, a memory unit 40, and a control unit 50.

Hereinafter, the above components are described sequentially.

The digital image managing apparatus 100 may include any devices that may store, manage, and play content of a digital image, for example, a digital camera, a cell phone, a smart phone, a laptop computer, a tablet PC, an e-book device, a device for digital broadcasting, a personal digital assistant (PDA), a portable multimedia player (PMP), or the like.

According to an embodiment, all operations of the digital image managing apparatus 100 are controlled by the control unit 50. The user input unit 10, which includes a key for generating an electric signal from a user and includes others, is included in the digital image managing apparatus 100. The electric signal from the user input unit 10 is sent to the control unit 50, and thus the control unit 50 controls the digital image managing apparatus 100 according to the electric signal.

The user input unit 10, according to an embodiment, may generate input data for a user to control an operation of the digital image managing apparatus 100. The user input unit 10 may include a key pad, a dome switch, a touch pad (operating in a contact-type capacitive method, pressure-type resistive overlay method, infrared beam detection method, surface ultrasonic transfer method, integral strain gauge method, Piezo electric effect method, or the like), a jog wheel, a jog switch, and the like. Particularly, if the touch pad forms a layered structure with the display unit 20 that are described below, this touch pad may be called a touchscreen.

In this case, the user input unit 10, according to an embodiment, may detect a touch gesture of a user on the touchscreen by using a touchscreen module (not shown) stored in the memory unit 40, and may send information related with the touch gesture to the control unit 50. The touchscreen module may be included as an additional hardware controller.

The user input unit 10, according to an embodiment, may receive a signal for setting the representative image and subsidiary images by selection from images displayed on the display unit 20.

In this case, according to an embodiment, the representative image and the subsidiary images may be stored in the memory unit 40 and displayed on the display unit 20.

Also, according to an embodiment, the user input unit 10 may receive a signal for resetting the representative image by selection from subsidiary images included in the file, wherein the file includes the representative image and the subsidiary images.

Also, according to an embodiment, the user input unit 10 may receive a signal for adding or deleting the subsidiary images included in the file, wherein the file includes the representative image and the subsidiary images.

Also, according to an embodiment, the user input unit 10 may receive a signal indicating whether or not to display the subsidiary images included in the file, wherein the file includes the representative image and the subsidiary images.

Also, according to an embodiment, the user input unit 10 may receive a signal for sending the file that includes the representative image and the subsidiary images.

Also, according to an embodiment, the user input unit 10 may receive a signal for deleting the file that includes the representative image and the subsidiary images.

For example, the signal for setting up the representative image and the subsidiary images, the signal for resetting the representative image, the signal for adding or deleting the subsidiary images, the signal for whether or not displaying the subsidiary images, the signal for sending the file, or the signal for deleting the file may be generated based on a touch gesture of a user that is input in the user input unit 10. For example, the touch gesture of the user may include tapping, touching and holding, double tapping, dragging, panning, flicking, dragging and dropping, swiping, and the like.

The display unit 20, according to an embodiment, may include at least one selected from the group consisting of a liquid crystal display, a thin film transistor-liquid crystal display, an organic light-emitting diode, a flexible display, and a three-dimensional (3D) display.

In the case where the display unit 20 and a touch pad mutually forms a layered structure and thus forms a touchscreen, the display unit 20 may be used both as an input unit as well as an output unit. The touchscreen may be formed so as to detect even touch input pressure as well as a touch input area and a touched area. The touchscreen may be formed so as to detect a proximity touch as well as a real touch.

The display unit 20, according to an embodiment, may display images stored in the memory unit 40. In this case, when the display unit 20 displays images from the file including the representative image and the subsidiary images, the representative image may be displayed by itself on the display unit 20.

Also, a user interface, which enables a user to select whether or not to display the subsidiary images included in the file, may be displayed together with the representative image. In this case, the subsidiary images included in the file may be displayed on the display unit 20, based on the signal received in the user input unit 10, according to an embodiment.

The file creating unit 30, according to an embodiment, may create the file including the representative image and the subsidiary images that are set based on the signal received in the user input unit 10.

The representative image and the subsidiary images may be set by selection from images displayed on the display unit 20, based on user input, according to an embodiment.

Also, according to an embodiment, the representative image corresponding to the file created in the file creating unit 30 may be reset by selection from subsidiary images included in the file, based on user input.

Also, the subsidiary images included in the file created by the file creating unit 30 may be added or deleted, based on user input according to an embodiment.

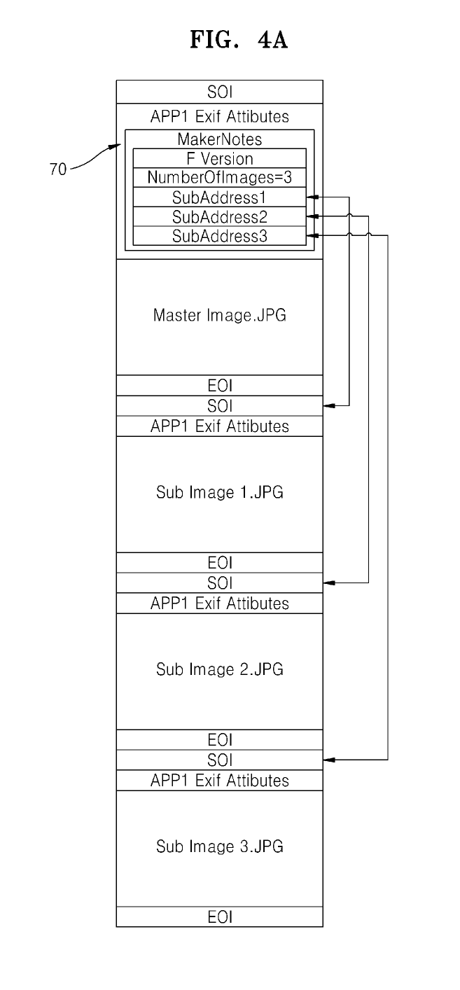

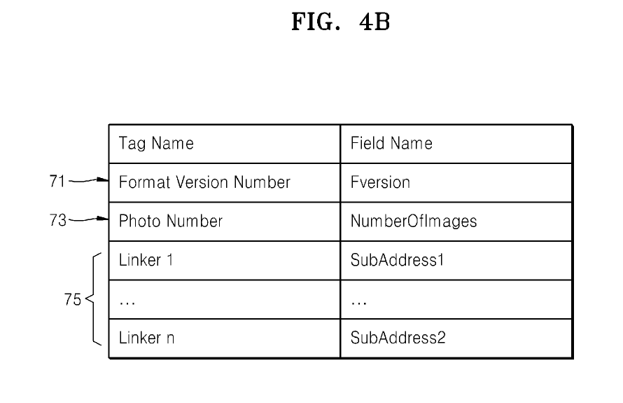

According to an embodiment, a structure of the file created in the file creating unit 30 is described below with reference to FIG. 4.

According to an embodiment, a memory unit 40 may store an image obtained by the digital image managing apparatus 100. Also, the memory unit 40 may store the file created in the file creating unit 30.

Also, the memory unit 40 may store a program for processing and controlling the control unit 50 and may store input/output data.

Meanwhile, the memory unit 40 may include at least one type of storage medium including a flash memory-type memory, a hard disk type memory, a multimedia card micro type memory, a card type memory (for example, SD, XD memory, or the like), a random access memory (RAM), a static random access memory (SRAM), a read-only memory (ROM), an electrically erasable programmable read-only memory (EEPROM), programmable read-only memory (PROM), a magnetic memory, a magnetic disc, an optical disc, etc.

Programs stored in the memory unit 40 may be classified, based on their functions, into a plurality of modules such as a user interface (UI) module (not shown), a touchscreen module (not shown), etc.

The UI module (not shown) may provide a specialized UI, a specialized graphical user interface (GUI), and the like, which are connected and operate with the digital image managing apparatus 100. Since functions of the UI module are well known to persons of ordinary skill in the art, a detailed explanation for the UI module is omitted.

The touchscreen module (not shown) may detect a touch gesture of a user on a touchscreen, and may send information about the touch gesture to the control unit 50. The touchscreen module may be included as an additional hardware controller.

For example, the touch gesture of the user may include tapping, touching and holding, double tapping, dragging, panning, flicking, dragging and dropping, swiping, and the like.

According to an embodiment, all operations of the digital image managing apparatus 100 are controlled by the control unit 50. In other words, the control unit 50 may generally control the user input unit 10, the display unit 20, the file creating unit 30, and the memory unit 40, by executing the programs stored in the memory unit 40.

According to an embodiment, the control unit 50 may control the memory unit 40 to store the file created by the file creating unit 30.

Also, according to an embodiment, the control unit 50 may control a plurality of images included in the file to be managed based on the representative image corresponding to the file created in the file creating unit 30.

For example, according to an embodiment, the control unit 50 may control the images or files stored in the memory unit 40 to be deleted from the memory unit 40, to be sent to an external device or server, or to be displayed on the display unit 20.

Also, according to an embodiment, when displaying the file created in the file creating unit 30 on the display unit 20, the control unit 50 may control the representative image, corresponding to the file, to be displayed on the display unit 20, together with a predetermined mark.

Also, according to an embodiment, the control unit 50 may control the user interface, which enables a user to select whether or not to display the subsidiary images included in the file together with the representative image.

For example, according to an embodiment, the control unit 50 may control the user interface to be displayed on the display unit 20 by using the UI module (not shown) stored in the memory unit 40.

In this case, according to an embodiment, the control unit 50 may control the subsidiary images, included in the file, to be displayed on the display unit 20 based on the signal received from the user input unit 10.

Also, according to an embodiment, the control unit 50 may control the file, created by the file creating unit 30, to be deleted from the memory unit 40 or to be sent to an external device or server. In this case, according to an embodiment, if the control unit 50 controls the representative image, included in the file, to be deleted from the memory unit 40, all of the subsidiary images included in the file may be collectively deleted from the memory unit 40.

Also, according to an embodiment, if the control unit 50 controls the representative images to be sent to the external device, the representative images included in the file may be collectively sent to the external device.

For example, according to an embodiment, the control unit 50 may control the user interface, which enables the images or files stored in the memory unit 40 to be deleted from the memory unit 40; to be sent to the external device or server; or to be displayed on the display unit 20, to be displayed on the display unit 20.

Operations of the digital image managing apparatus 100 are described sequentially below.

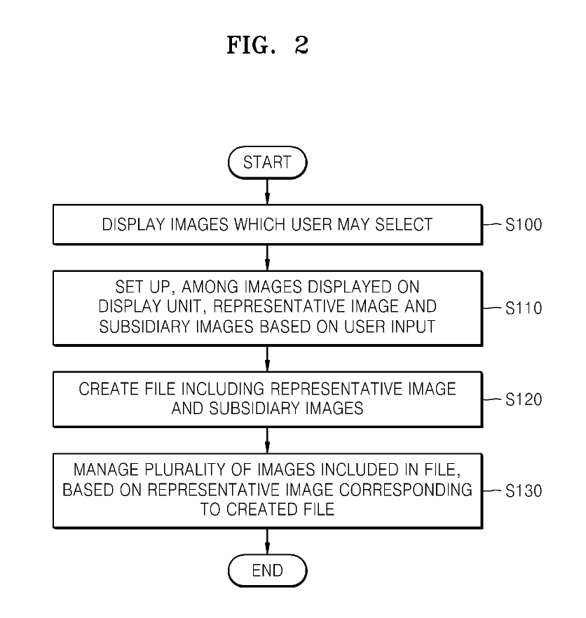

FIG. 2 is a flowchart illustrating an example method of creating and managing a file including a representative image, according to an embodiment.

In operation S100, the digital image managing apparatus 100 displays images on the display unit 20, which a user may select.

For example, according to an embodiment, the images may include any content that may be managed in the digital image managing apparatus 100.

According to an embodiment, the content may include at least one of still image content (for example, photos, pictures, and the like), text content (for example, poems, novels, letters, text files, detailed explanations about content, and the like), video content (for example, personal videos, movies, music videos, images of TV programs, and the like), music content (for example, music, musical programs, radio, and the like), and event content (for example, schedules, anniversaries, travel plans, and the like). In other words, according to an embodiment, the content may include various types of content as well as multimedia content.

In operation S110, the digital image managing apparatus 100 sets the representative image and subsidiary images based on user input.

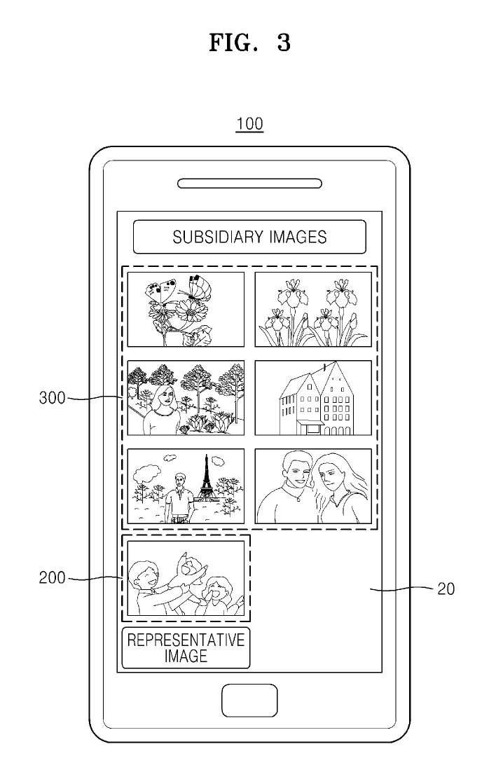

For example, one image may be selected from images displayed in operation S100 to be preferentially set as the representative image, and one or more subsidiary images may be set so as to be created and managed as one file together with the representative image. Further details are provided below with reference to FIG. 3.

The priority in setting the representative image and the subsidiary images is not limited thereto.

In operation S120, the digital image managing apparatus 100 creates a file including the representative image and the subsidiary images that have been set in operation S110.

For example, the representative image corresponding to the file may be reset by selection from subsidiary images included in the file, based on user input. Also, the subsidiary images included in the file may be added or deleted, based on the user input. In this case, a new file may be created.

Further details of creating the new file are described below with reference to FIG. 4.

In operation S130, the digital image managing apparatus 100 manages a plurality of images included in the file created in operation S120, based on the representative image.

For example, when the file is displayed on the display unit 20, the representative image corresponding to the file may be displayed by itself on the display unit 20, together with a predetermined mark.

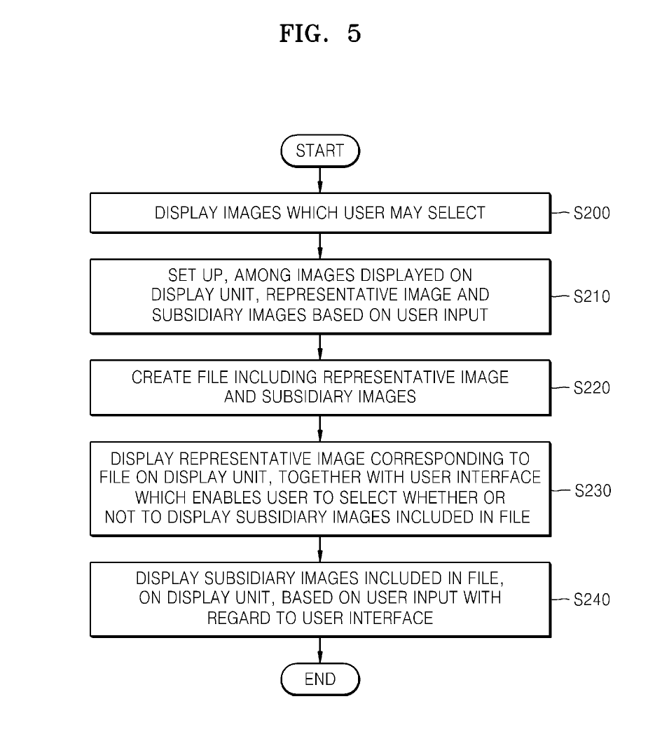

In this case, the predetermined mark may be the user interface, which enables a user to select whether or not to display the subsidiary images included in the file. In this case, the subsidiary images, included in the file, may be displayed on the display unit 20, based on user input. Further details are described below with reference to FIGS. 5 through 7.

Also, the plurality of images included in the file may be deleted from the memory unit 40 or sent to an external device or server.

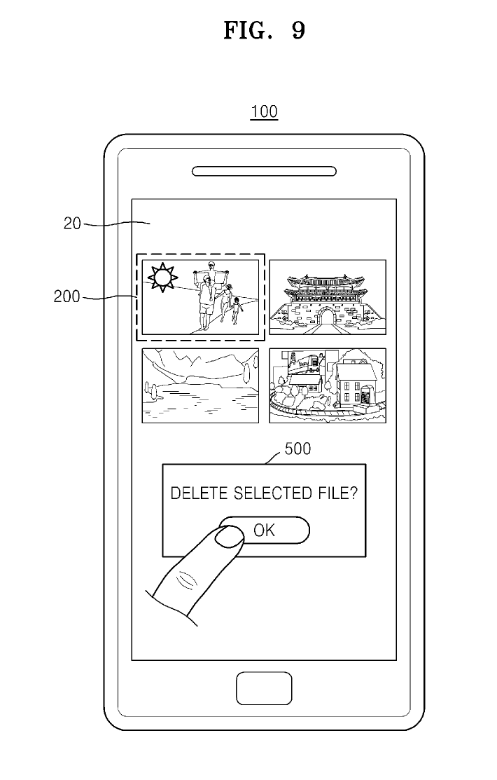

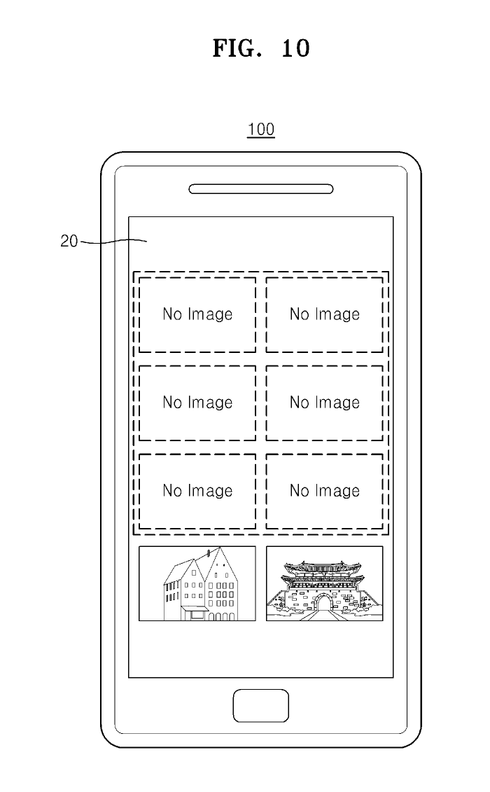

In this case, if the representative image included in the file is deleted from the memory unit 40, the subsidiary images included in the file may be collectively deleted from the memory unit 40. Further details are described below with reference to FIGS. 9 through 10.

Also, if the representative image included in the file is sent to the external device, the subsidiary images included in the file may be collectively sent to the external device.

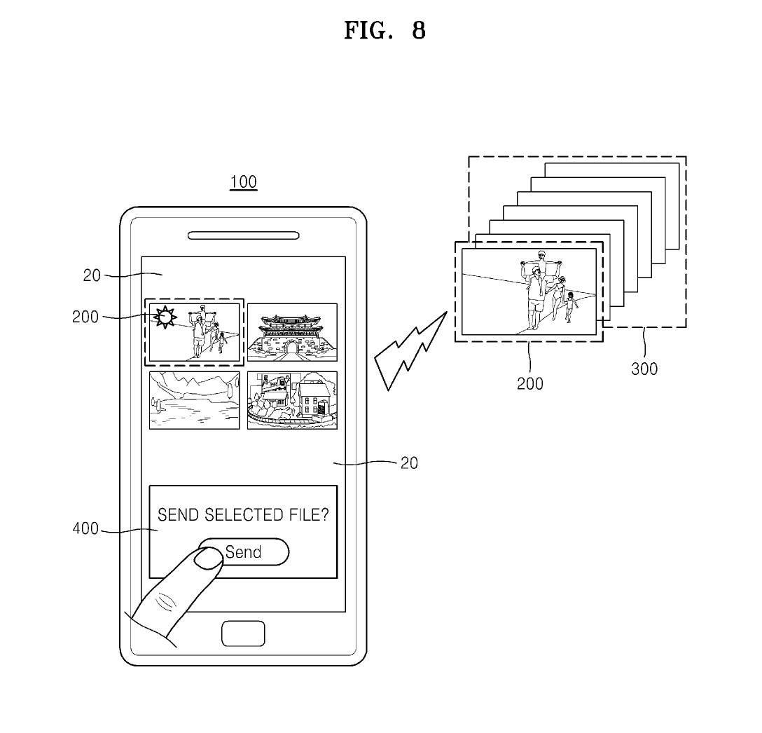

Further details are described below with reference to FIG. 8.

FIG. 3 is a diagram illustrating an example user interface for selecting a representative image and subsidiary images in the digital image managing apparatus 100, according to an embodiment.

For example, as illustrated in FIG. 3, the images stored in the memory unit 40 may be displayed on the display unit 20 of the digital image managing apparatus 100.

In this case, some images selected from displayed images, may be generated as one file in accordance with intent of a user.

For example, by selection from displayed images according to the intent of the user, the representative image 200 may be preferentially set.

Also, by selection from displayed images, one or more subsidiary images 300 to be managed together with the representative image 200, as one file, may be set based on user input. However, the priority in setting the representative image 200 and the subsidiary images 300 is not limited thereto.

Also, after the file including the representative image 200 and the subsidiary images 300 is created, the representative image and the subsidiary images may be changed based on the user input.

FIGS. 4A though 4B are conceptual diagrams illustrating exemplary structures of files, according to embodiments.

For example, as illustrated in FIG. 4A, a file may follow a format of Joint Photography Experts Group (JPEG).

In the format of JPEG, a header may include attribute information of Exchangeable Image File Format (Exit).

In this case, the attribute information of the Exit may include visual information standards, equipment information standards, and an Exif Image File Directory (IFD).

For example, information about a date of photographing, a date of correction, a size of a file, a name of a file, and the like, may be included in the visual information standards. And, Information about an equipment manufacturer, a model, shutter speed, a focal distance, ISO speed, and the like, may be included in the equipment information standards.

Also, as information about space for storing the image and equipment information, the Exif IFD may include MakerNotes 70.

The MakerNotes 70 may include unique information about each manufacturer, for example, independent metadata standards of a device manufacturer, deficient information and debugging information at the Exif Field, and the like.

According to an embodiment, the file utilizes the MakerNote of the JPEG standards, and thus the representative image may be displayed in a legacy device. According to an embodiment, the digital image managing apparatus may also display the subsidiary images as well as the representative image based on information of the MakerNote.

Also, as illustrated in the FIG. 4B, information included in the MakerNotes 70 basically may have a table, as described below.

The table may include, for example, Format Version Number 71, Photo Number 73, and Linkers 75.

Also, according to an embodiment, a feature of a maker, and a version of the digital image managing apparatus may be entered in the Format Version Number 71. The number of the subsidiary images included in the file may be entered in the Photo Number 73.

Also, each StartAddress for each of the subsidiary images may be entered in the Linkers 75.

However, information about the MakerNote may be omitted for the subsidiary images.

Operations of the digital image managing apparatus 100 are described below sequentially.

FIG. 5 is a flowchart illustrating an example method of displaying a file according to a representative image, according to an embodiment.

Operations S200 through S220 correspond to operations S100 through S120 of FIG. 1, and thus detailed explanations are omitted.

In operation S230, the digital image managing apparatus 100 displays the representative image corresponding to the file created in operation S220, together with the user interface which enables a user to select whether or not to display the subsidiary images, on the display unit.

For example, when the images and files stored in the memory unit 40 are displayed on the display unit 20, all of the stored images and files may be either displayed together in one window or displayed individually in each window.

In this case, when the file including the representative image and the subsidiary images are displayed on the display unit 20, the representative image corresponding to the file may be displayed by itself on the display unit 20, together with a predetermined mark.

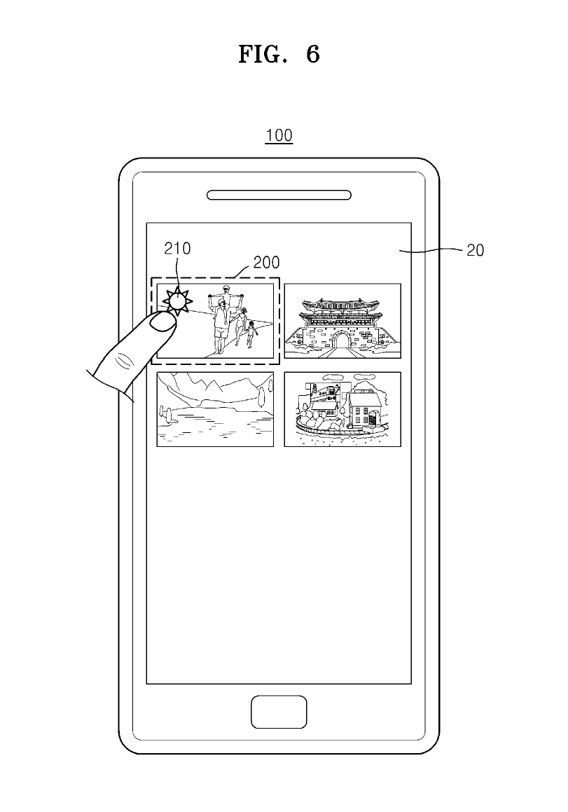

The predetermined mark may be, for example, a user interface which enables a user to select whether or not to display the subsidiary images included in the file. Further details are described below with reference to FIG. 6.

In operation S240, the digital image managing apparatus 100 displays the subsidiary images on the display unit 20, based on user input with regard to the user interface displayed in operation S230.

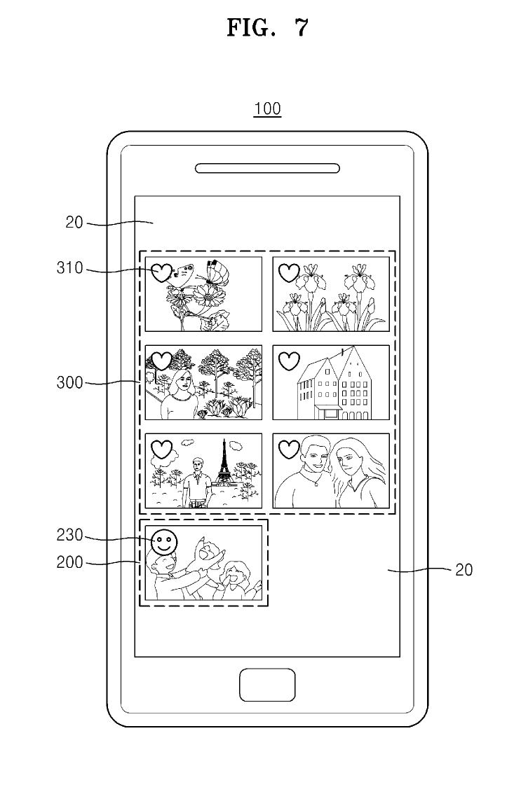

In this case, the subsidiary images may be displayed with predetermined identification marks so as to be distinguished from the representative image. Further details are described below with reference to FIG. 7.

FIGS. 6 and 7 are diagrams respectively illustrating an example user interface for displaying a file including a representative image and subsidiary images on the display unit of the digital image managing apparatus, according to an embodiment.

For example, as illustrated in FIG. 6, the images and files stored in the digital image managing apparatus 100 may be displayed on the display unit 20.

In this case, when the file including the representative image 200 and the subsidiary images 300 is displayed on the display unit 20, the representative image 200 corresponding to the file may be displayed by itself on the display unit 20, together with a predetermined mark 210.

The predetermined mark 210 may be, for example, the user interface which enables a user to select whether or not to display the subsidiary images 300 included in the file.

In this case, as illustrated in FIG. 6, if the user touches and holds an area of the predetermined mark 210, a signal for whether or not displaying the subsidiary images may be generated. However, user input is not limited to a touch gesture.

Accordingly, as illustrated in FIG. 7, the subsidiary images included in the file may be displayed on the display unit 20 of the digital image managing apparatus 100.

Also, the representative image 200 may be displayed together with the subsidiary images 300 included in the file. In this case, an identification mark may be displayed so as to distinguish the subsidiary images and the representative image.

For example, as illustrated in FIG. 7, a representative image identification mark 230 may be displayed together with the representative image 200, and subsidiary image identification marks 310 may be displayed together with the subsidiary images 300.

FIG. 8 is a diagram illustrating an example method of sending a file in the digital image managing apparatus 100, according to an embodiment.

For example, as illustrated in FIG. 8, a user interface 400, for sending the images or files stored in the digital image managing apparatus 100 to an external device or server by using a network, may be displayed on the display unit 20 of the digital image managing apparatus 100.

In this case, when a user selects “send” in the user interface 400, after selecting the representative image 200, the digital image managing apparatus 100 may receive a signal for sending the representative image 200 selected by the user.

Accordingly, the representative image 200 selected by the user may be sent to an external device or server by using the network. Thus, the subsidiary images 300 included in the file may be collectively sent to the external device or server by using the network.

FIGS. 9 and 10 are diagrams respectively illustrating an example method of deleting a file in the digital image managing apparatus 100, according to an embodiment.

For example, as illustrated in FIG. 9, a user interface 500, for deleting images or files stored in the digital image managing apparatus 100 from the memory unit 40, may be displayed on the display unit 20 of the digital image managing apparatus 100.

In this case, if a user selects “ok” in the user interface 500, after selecting the representative image 200, the digital image managing apparatus 100 may receive a signal instructing the apparatus 100 to delete the representative image 200 selected by the user from the memory unit 40.

Accordingly, as illustrated in FIG. 10, the representative image 200 selected by the user may be deleted from the memory unit 40, and thus the subsidiary images 300 included in the file may also be collectively deleted from the memory unit 40.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be implemented by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While one or more embodiments have been described with reference to the figures, it will be understood by those of ordinary skill in the art that various changes in form and details may be made therein without departing from the spirit and scope of the invention as defined by the following claims.

What is claimed is:

1. A method of managing digital images, the method comprising:
displaying images that a user may select;
setting, by selection from images displayed on a display unit, a representative image and subsidiary images based on user input;
creating a file including the representative image and the subsidiary images; and
managing a plurality of images included in the file, based on the representative image corresponding to the created file.

2. The method of claim 1, wherein the representative image in the file may be reset, by selection from the subsidiary images included in the file, based on the user input.

3. The method of claim 1, wherein the subsidiary images included in the file may be added or deleted based on the user input.

4. The method of claim 1, wherein managing the plurality of images included in the file comprises displaying the representative image corresponding to the created file on the display unit, together with a predetermined mark, when displaying the created file on the display unit.

5. The method of claim 4, wherein the predetermined mark is a user interface that enables a user to select whether or not to display the subsidiary images included in the file.

6. The method of claim 5, further comprising, based on user input received by the user interface, displaying the subsidiary images included in the file, on the display unit.

7. The method of claim 1, wherein the managing the plurality of images included in the file comprises, when the representative image is sent, sending the plurality of images included in the file corresponding to the representative image.

8. The method of claim 1, wherein the managing the plurality of images included in the file comprises, when the representative image is deleted, deleting the plurality of images included in the file corresponding to the representative image.

9. A digital image managing apparatus comprising:
a display unit that displays images stored in the digital image managing apparatus;
a user input unit that receives a signal for setting a representative image and subsidiary images based on selection from images displayed on the display unit;
a file creating unit that creates a file including the representative image and the subsidiary images that are set based on the signal received in the user input unit; and
a control unit that manages a plurality of images included in the file, based on the representative image corresponding to the file created in the file creating unit.

10. The digital image managing apparatus of claim 9, wherein the representative image of the file may be reset by selection of an image, from the subsidiary images included in the file, based on the user input.

11. The digital image managing apparatus of claim 9, wherein the subsidiary images included in the file may be added or deleted, based on the user input.

12. The digital image managing apparatus of claim 9, wherein the control unit controls the representative image corresponding to the file to be displayed on the display unit, together with a predetermined mark.

13. The digital image managing apparatus of claim 9, wherein the control unit controls a user interface that enables a user to select whether or not to display the subsidiary images, included in the file, to be displayed on the display unit, together with a representative image.

14. The digital image managing apparatus of claim 13, wherein the user input unit receives a signal indicating whether or not to display the subsidiary images included in the file, and
wherein the control unit controls the subsidiary images, included in the file, to be displayed on the display unit, based on the received signal in the user input unit.

15. The digital image managing apparatus of claim 9, wherein the control unit controls, when the representative image is sent, the file corresponding to the representative image to be sent.

16. The digital image managing apparatus of claim 9, wherein the control unit controls, when the representative image is deleted, the file corresponding to the representative image to be deleted.

17. A non-transitory computer readable storage medium that contains computer program instructions stored thereon that, when executed by a processor, cause the processor to perform a method of managing digital images, wherein the method of managing digital images comprises:
displaying images which a user may select;
setting, by selection from images displayed on a display unit, a representative image and subsidiary images, based on user input;
creating a file including the representative image and the subsidiary images; and
managing a plurality of images included in the file, based on the representative image corresponding to the created file.

18. The non-transitory computer readable storage medium of claim 17, wherein the representative image of the file may be reset by selection from the subsidiary images included in the file, based on the user input.

19. The non-transitory computer readable storage medium of claim 17, wherein the managing the plurality of images included in the file comprises, when the representative image is sent, sending the plurality of images included in the file corresponding to the representative image.

20. The computer readable storage medium of claim 17, wherein the managing the plurality of images included in the file comprises, when the representative image is deleted, deleting the plurality of images included in the file corresponding to the representative image.
